(19) United States
(12) Patent Application Publication
(10) Pub. No.: US 2016/0249157 A1
(43) Pub. Date: Aug. 25, 2016

(54) ADAPTABLE COIL-NFC ANTENNA FOR POWERED AND UNPOWERED APPLICATIONS

(71) Applicant: Empire Technology Development LLC, Wilmington, DE (US)

(72) Inventor: Kevin S. Fine, Yverdon-les-Bains (CH)

(21) Appl. No.: 14/437,831

(22) PCT Filed: Nov. 21, 2014
(86) PCT No.: PCT/US14/66975

§ 371 Date: Apr. 22, 2015

(51) Int. Cl. H04W 4/00; H04B 5/00

(52) U.S. Cl. CPC H04W 4/008; H04B 5/0031; H04B 5/0037

(57) ABSTRACT

Technologies are generally described to provide adaptable near field communication (NFC) in portable devices to enable a portable device to provide wireless power transfer (WPT) functionality and NFC functionality. According to some examples, a wireless power antenna installed on the portable device may be configured to function as a WPT antenna and as an NFC antenna. For example, the wireless power antenna may be a coil, which may be modified to adjust a quality factor (Q) by incorporation of a switchable resistor element. The modified coil may function as a wireless power receiver/transmitter with a high Q value when the resistor element is added and as an active NFC antenna with a low Q value when the resistor is not added. Additionally, the modified coil may further enable the portable device to function as a passive NFC antenna when the portable device is unpowered.

### BACKGROUND

Unless otherwise indicated herein, the materials described in this section are not prior art to the claims in this application and are not admitted to be prior art by inclusion in this section.

Near Field Communication (NFC) technology may be employed with portable devices to enable short-range wireless communication when the portable device is within a predefined range of another device or transmitter. Active NFC may be enabled when an NFC antenna is connected with an external power supply, such as a battery of a portable device. In some portable devices, such as smartphones, passive NFC systems may not function because additional shielding caused by elements of the smartphone, such as the battery and other metal layers, may prevent the NFC antenna from receiving enough power to operate. Since the NFC antenna incorporated with smartphones needs power to operate, contactless systems and applications, such as a contactless payment system may not be usable if the battery of the smartphone is uncharged. Wireless Power Transfer (WPT) technology may enable a smartphone to be wirelessly charged employing a WPT antenna installed on the smartphone, in addition to the NFC antenna. However, even with widespread WPT technology, portable devices may become uncharged, inhibiting the ability to use contactless systems installed on the portable devices.

### SUMMARY

According to some examples, methods are described to provide adaptable near field communication (NFC) for powered and unpowered applications in a portable device. The method may include receiving a wireless signal; determining whether the received wireless signal is a wireless power transfer (WPT) signal; in response to a determination that the received wireless signal is the WPT signal, charging a battery of the portable device; and in response to a determination that the received wireless signal is not the WPT signal, modifying a configuration of an antenna on the portable device to support NFC. The method may also include determining whether a power level of the portable device is sufficient to support active NFC and in response to a determination that the power level of the portable device is insufficient to support active NFC, enabling passive NFC through the modified configuration antenna, where the passive NFC relies on power derived from the received wireless signal through the modified configuration antenna.

According to other examples, a portable device capable to support adaptable near field communication (NFC) for powered and unpowered applications is described. The portable device may include a processing block, a portable power source, a switchable antenna configured to support wireless power transfer (WPT) in a first configuration and NFC in a second configuration and to receive a wireless signal, and a secure element (SE) coupled to the switchable antenna. The SE may be configured to determine whether the received wireless signal is a WPT signal; in response to a determination that the received wireless signal is the WPT signal, charge a battery of the portable device; in response to a determination that the received wireless signal is not the WPT signal, modify a configuration of the antenna to the second configuration; determine whether a power level of the portable device is sufficient to support active NFC; in response to a determination that the power level of the portable device is insufficient to support active NFC, enable passive NFC through the antenna in the second configuration, where the passive NFC relies on power derived from the received wireless signal through the antenna in the second configuration; and in response to a determination that the power level of the portable device is sufficient to support active NFC, enable active NFC through the antenna in the second configuration, where the active NFC relies on power derived from the battery of the portable device.

According to further examples, a near field communication (NFC) module capable to support powered and unpowered applications is described. The NFC module may include a switchable antenna configured to support wireless power transfer (WPT) in a first configuration and NFC in a second configuration and to receive a wireless signal; and a secure element (SE) coupled to the switchable antenna. The SE may be configured to determine whether the received wireless signal is a WPT signal; in response to a determination that the received wireless signal is the WPT signal, charge a battery of a portable device that hosts the NFC module; in response to a determination that the received wireless signal is not the WPT signal, modify a configuration of the antenna to the second configuration; determine whether a power level of the portable device that hosts the NFC module is sufficient to support active NFC; in response to a determination that the power level of the portable device is insufficient to support active NFC, enable passive NFC through the antenna in the second configuration, where the passive NFC relies on power derived from the received wireless signal through the antenna in the second configuration; in response to a determination that the power level of the portable device is sufficient to support active NFC, enable active NFC through the antenna in the second configuration, where the active NFC relies on power derived from the battery of the portable device; and upon detection of a completion of the passive NFC or the active NFC, switch the antenna to the first configuration.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates mounting of a secure element (SE) integrated circuit (IC) in a smartcard;

FIG. 2 illustrates a conceptual diagram of a subscriber identity module (SIM)-centric vision of how to use an SE chip for a payment application on a smartphone;

FIG. 3 illustrates an example comparison of power versus frequency distributions for NFC and wireless power transfer (WPT) communications;

FIG. 4 illustrates an example switchable NFC/WPT antenna circuit and implementation of NFC and power connections on a charger pack of a smartphone;

FIG. 5 illustrates a conceptual diagram of a portable device operational blocks implementing a switchable NFC/WPT antenna;

FIG. 6 illustrates a general purpose computing device, which may be used to implement adaptable coil-NFC antenna systems for powered and unpowered applications;

FIG. 7 is a flow diagram illustrating an example process to implement adaptable coil-NFC antenna systems for powered and unpowered applications that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

Briefly stated, technologies are generally described to provide adaptable near field communication (NFC) in portable devices to enable a portable device to provide wireless power transfer (WPT) functionality and NFC functionality. According to some examples, a wireless power antenna installed on the portable device may be configured to function as a WPT antenna and as an NFC antenna. For example, the wireless power antenna may be a coil, which may be modified to adjust a quality factor (Q) by incorporation of a switchable resistor element. The modified coil may function as a wireless power receiver/transmitter with a high Q value when the resistor element is not added and as an active NFC antenna with a low Q value when the resistor is added. Additionally, the modified coil may further enable the portable device to function as a passive NFC antenna when the portable device is unpowered.

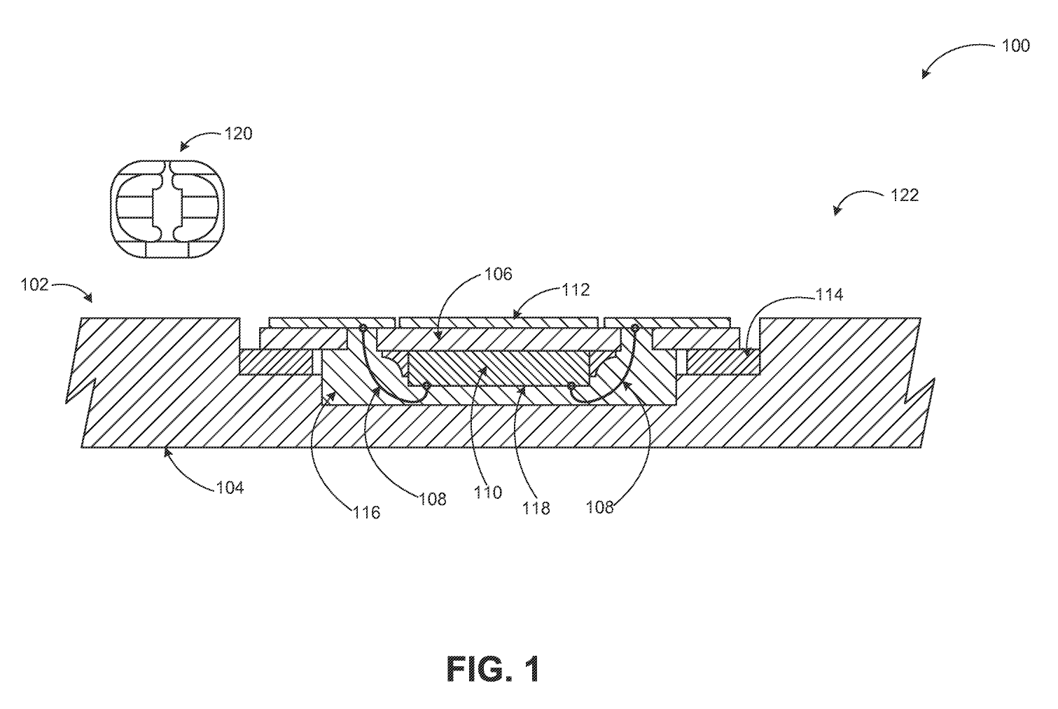

FIG. 1 illustrates mounting of a secure element (SE) integrated circuit (IC) in a smartcard, arranged in accordance with at least some embodiments described herein.

A diagram 100 shows an example SE chip 110 mounted within a smartcard 102 to enable secure NFC between portable devices. A cross section view 122 illustrates the SE chip 110 mounted within the smartcard 102. An example smartcard 102 may be a subscriber identity module (SIM) card associated with a portable device. As shown in the cross section view 122, the SE chip 110 may be embedded within a substrate 106 with an active side 118 of the SE chip 110 in contact with an encapsulation portion 116 of the smartcard 102. One or more bond wires 108 may electrically connect electrical contacts 112 on the surface of the smartcard 102 with the SE chip 110. The substrate 106 including the SE chip 110 may be adhered to the smartcard 102 employing a thermoplastic adhesive 114 such as hot-melt. A top view 120 illustrates an example configuration of the electrical contacts 112 associated with the SE chip 110 on the surface of the smartcard 102.

In a system according to embodiments, the SE chip 110 may be incorporated with the smartcard 102 and/or a SIM card associated with a portable device equipped with NFC capabilities. The SIM card may provide identification, authentication, data storage and application processing to enable the portable device to execute secure transactions employing NFC. The SE chip 110 of the smartcard 102 may store sensitive data such as credentials, keys, passwords, instructions and other secure information to enable the secure NFC. The sensitive data may be stored encrypted within the SE chip 110 and may be decrypted by processors of the SE chip 110. The SE chip 110 may also be configured to detect chip tampering and to erase the secure information if tampering is detected. In some examples, the SE chip 110 may be covered in a wire mesh configured to hide the chip visually and electrically, and if the mesh is removed and/or otherwise tampered with, the SE chip 110 may stop functioning and may erase the secure information.

An example secure transaction employing NFC may include a contactless payment system using a portable device provisioned with a payment application and payment account information. An SE chip incorporated with the portable device may store and encrypt the secure payment account information, such as a credit card number and credentials. The portable device may use NFC to enable the payment information to be wirelessly exchanged between the portable device and a point of sale terminal when the portable device is placed within a predefined range of the point of sale terminal.

Active NFC as described herein may be powered by a battery of the portable device. The battery may be wirelessly charged employing WPT when a WPT antenna is incorporated with the portable device and the portable device is placed within a predefined range of a power transmitter. Some portable devices may include both an NFC antenna and a WPT antenna to enable both NFC and WPT functionality. In some embodiments as described herein, an installed WPT antenna may be configured to function also as an NFC antenna to eliminate the need for two separate antennas. Additionally, the WPT antenna may enable the NFC antenna to function when the portable device is unpowered such as when the battery is uncharged, which may enable applications, such as the contactless payment system, to operate when the portable device is unpowered.

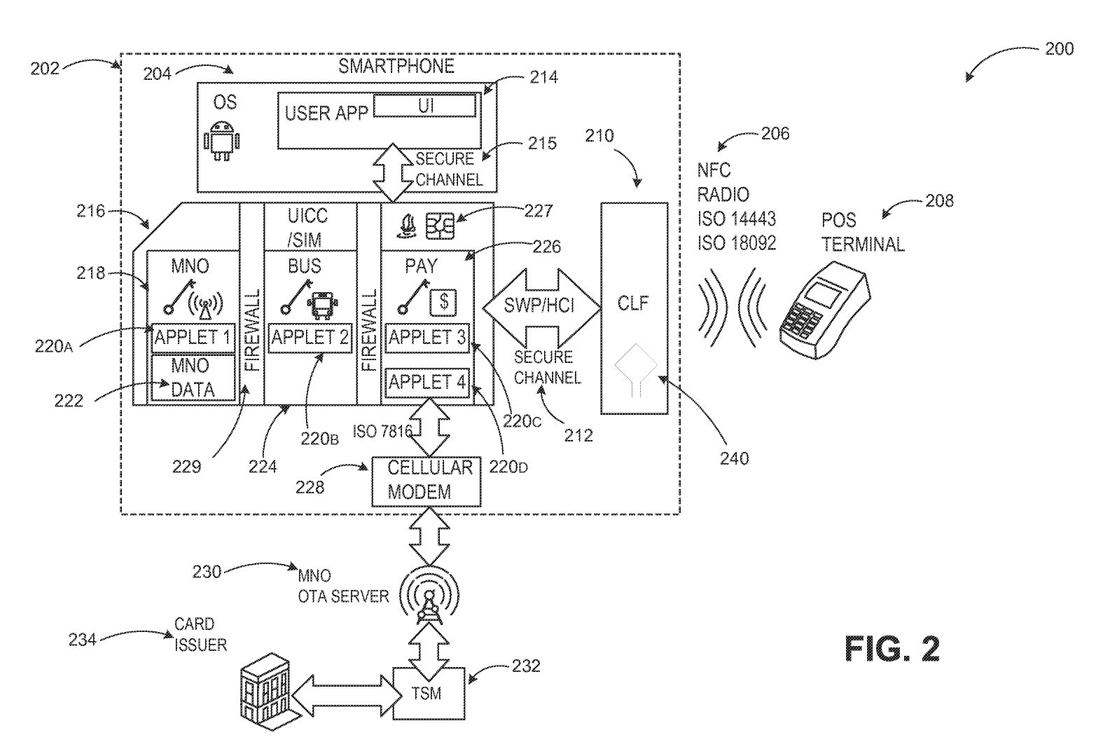

FIG. 2 illustrates a conceptual diagram 200 of a subscriber identity module (SIM)-centric vision of how to use an SE chip for a payment application on a smartphone, arranged in accordance with at least some embodiments described herein.

As described herein, a portable device 202 such as a smartphone may be equipped with near field communication (NFC) 206 capabilities to enable contactless payment with a point of sale (POS) terminal 208. The portable device 202 may implement a SIM card 216, or a Universal Integrated Circuit Card (UICC), as the NFC payment card. In example embodiments, the SIM card 216 may be and/or may include an SE chip configured to store and encrypt secure information. The SE chip may be illustrated by contacts 227 in the diagram 200.

As also illustrated in the diagram 200, a contactless payment application associated with the portable device 202 may include one or more software components. The software components may be executed on a processor 204 of the portable device 202 and/or on a processor of the SIM card 216. Example software components may include a user application 214, which may operate on the processor 204 of the portable device 202, and at least one SE applet (for example, applets 220A-220D) which may operate on the SIM card 216 processor. The SE applet(s) may be responsible for high security tasks such as providing information for NFC 206 with the POS terminal 208. In some examples, secure numbers and information stored on the SIM card 216 may be used to calculate other information, which may be shared by the SIM card 216.

In example embodiments, the SIM card 216 may be configured to host one or more different secure services or applications. Example applications may include a Mobile Network Operator (MNO) service 218 including an associated MNO applet 220A and MNO authentication data 222 for mobile network authentication, a ticketing and public transportation service 224, which may include a payment applet 220B, and a credit or debit card payment service 226 and associated payment applets 220C, 220D. The described applications are not intended to be limiting, and other applications may also be hosted, such as authentication and signature verification systems, corporate badges and electronic identification systems, loyalty programs, a secure facility access application, a non-monetary resource access application, and an identification application, and others. Each of the services maintained on the SIM card 216 may be protected by a firewall 229 from the other services.

In an example embodiment, the applets (for example, applets 220A-220D) of the SIM card 216 may communicate over a secure channel 215 with less secure software operating on the main processor 204 of the portable device 202 and may be responsible for security sensitive tasks, such as storing sensitive information of the associated service and communication 212 with the POS terminal 208 through a contactless front end (CLF) 210 of the portable device 202. The CLF 210 may include radio hardware such as an antenna 240 configured to enable NFC for contactless payment and other contactless functionality.

In an example scenario illustrated in the diagram 200, data and applets of the SIM card 216 may be controlled by an MNO server 230, such as a mobile network service provider, via a secure data connection over a cellular modem network 228. The MNO server 230 may enable remote installation and updating of payment cards and account information on the SIM card 216 of the portable device 202 over the cellular modem network 228. Additionally, because of increased security demands of the SIM card 216, software to be installed on the SIM card 216 may need to be approved by a trusted service manager (TSM) 232. The TSM 232 may be a third party that verifies software to be loaded on the SIM card 216. In some examples, a card issuer 234 such as a financial institution may coordinate with the TSM 232 in order to load payment information associated with a particular card associated with the card issuer 234 on the portable device 202.

In other example embodiments, an SE chip may be installed directly within the hardware of the portable device 202 rather than on the SIM card 216 such that the portable device 202 may be provided with an NFC antenna and including a built-in SE chip. In this scenario, a portable device manufacturer may be responsible for installation of payment information and payment cards on the portable device 202 via firmware downloads and installation. In yet other scenarios, a physical SE chip may not be installed, and a Host Card Emulation (HCE) technology may be employed which may emulate an SE chip in software operating on the portable device processor. In such a scenario employing HCE technology, the card issuer 234 may not have to negotiate with another entity, such as the TSM 232, in order to manage payment cards.

As previously described, the antenna 240 to enable NFC may be installed at the CLF 210 of the portable device 202. The antenna 240 may operate according to ISO/IEC 14443, which is an international standard that specifies transmission and communication protocols. Based on the standard, the antenna 240 may operate at a frequency around 13.56 MHz. The antenna 240 may be configured to enable NFC for contactless payment while the portable device 202 is charged and has power. However, if the battery of the portable device 202 is uncharged, the antenna 240 may not be able to function to enable contactless payment.

In a system according to embodiments, WPT may also be incorporated with the portable device 202 to enable wireless power transmission for charging the portable device without requiring the portable device 202 to be plugged into a power source. WPT may include a WPT antenna configured to enable power to be wirelessly exchanged when the portable device 202 is placed within a predefined range of a power source. An example range may be up to several meters. Without modification, a WPT antenna as described herein may not be able to function as an NFC antenna, and the portable device may need to include both a WPT antenna and an NFC antenna to enable wireless power exchange and near field communication concurrently. Inclusion of both the WPT antenna and the NFC antenna on the portable device 202 may necessitate more physical space, more working parts of the portable device 202, and additional expense.

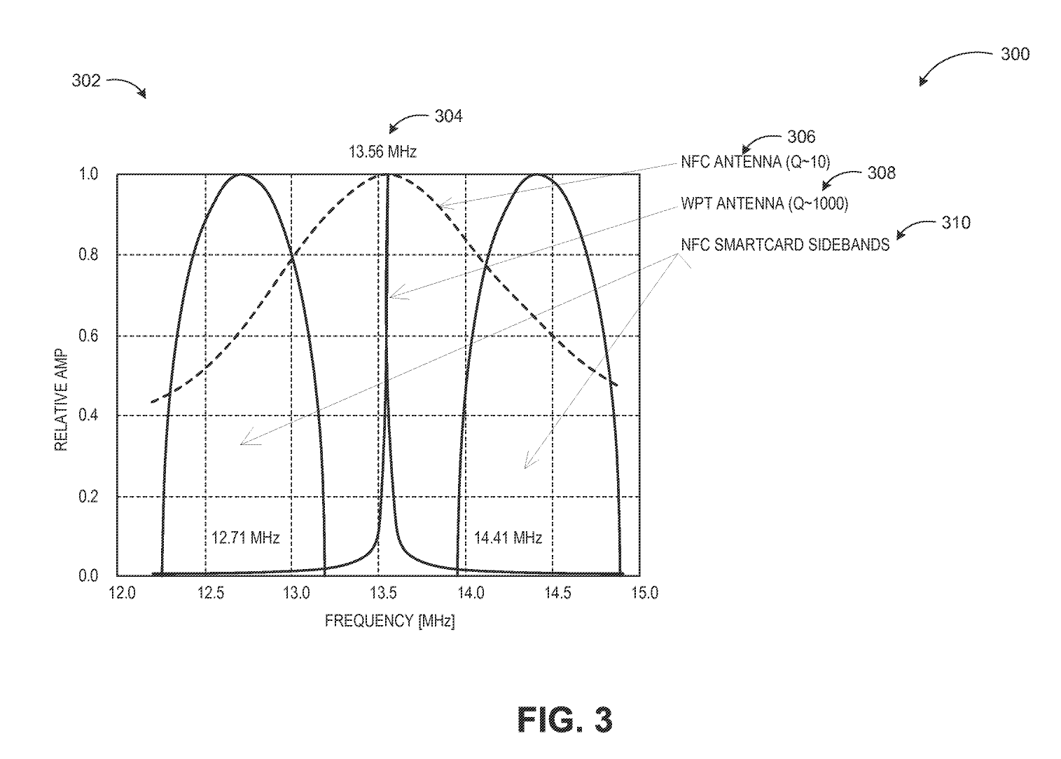

FIG. 3 illustrates an example comparison of power versus frequency distributions for NFC and WPT communications, arranged in accordance with at least some embodiments described herein.

A diagram 300 shows a plot 302 of example amplitudes versus frequency distributions of a WPT antenna 308 and an NFC antenna 306 in response to an excitation, which may illustrate that a WPT antenna without additional modification may not function as an NFC antenna. The curves in the plot 302 are normalized to a maximum of 1, although the maximum amplitude due to WPT may be larger than for NFC without normalization.

An example NFC antenna as previously described herein may have an operating frequency around 13.56 MHz 304. A resonant WPT antenna may also have an operating frequency around 13.56 MHz 304. The 13.56 MHz frequency may be chosen as the operating frequencies for the antennas based on the international communication standard ISO/IEC 14443. In other example embodiments, inductive WPT antennas may also be used, however, inductive WPT antennas may have a resonant frequency in a range from 100 to 250 kHz, which does not overlap with the NFC antenna frequency around 13.56 MHz. Since resonant WPT antennas have an operating frequency similar or substantially the same as the NFC operating frequency, a resonant WPT antenna may be able to function as an NFC antenna in some scenarios.

As shown in the plot 302 of the diagram 300, the NFC antenna 306 has a low quality factor (Q) of about 10. Because the NFC antenna 306 follows the ISO/IEC 14443 communication standard, which operates over a wide bandwidth, the NFC antenna 306 may transmit information in sidebands 310 centered at 12.71 and 14.41 MHz, where the sidebands may represent NFC smartcard sidebands. As also shown in the plot 302, the WPT antenna 308 may have a narrow resonance curve, centered at 13.56 MHz, and may have a high Q value of around 1000, which may enable the WPT antenna 308 to transmit power efficiently. The WPT antenna 308 may behave as a narrow frequency filter and may remove information from an NFC signal, which may make it unacceptable as an NFC antenna.

The curves shown in the plot 302 of the diagram 300 may be derived from the Universal Resonance Curve given by:

$$I ( f , Q ) = \frac{1}{\sqrt{1 + {{Q}^{2} ( \frac{f}{{f}_{0}} - \frac{{f}_{0}}{f} )}^{2}}}$$

In the above formula, f₀ may be the resonance frequency, which is 13.56 MHz in the case of both the NFC antenna 306 and the WPT antenna 308, as previously discussed. The importance of the Q value may be shown by figure of merit, U, given by:

U=k\sqrt{Q_{T}, Q_{R}},

where Q_{R} and Q_{T} are quality factors of transmit and receive circuits, and k is a magnetic coupling which decreases with distance.

The optimum power transfer efficiency may be given by:

$${η}_{Opt} = \frac{{U}^{2}}{{( 1 + \sqrt{1 + {U}^{2}} )}^{2}}$$

illustrating that reducing the Q value from 1000 to 10 may decrease a power transfer efficiency up to a factor of 100, which may demonstrate why a WPT antenna may not function as an NFC antenna, and vice versa. For example, a low Q value of 10 may cause the WPT antenna to be inefficient and/or inoperable as a power transmitter and receiver.

In a system according to embodiments, the WPT antenna 308 may be modified to enable the WPT antenna 308 to function as an NFC antenna by incorporating a switchable resistor with the WPT antenna 308. The switchable resistor may enable the Q value of the WPT antenna 308 to be reduced from 1000 to 10, which may support NFC functionality.

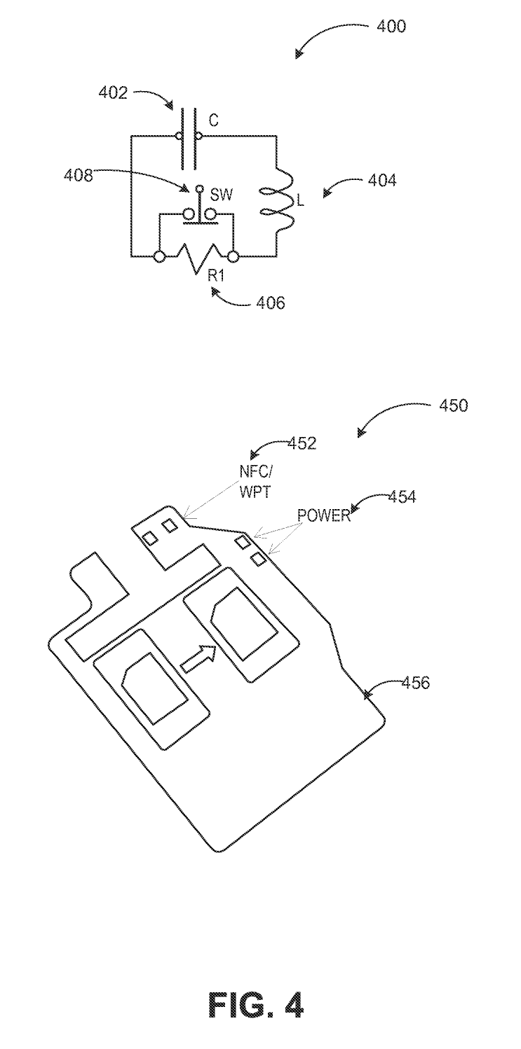

FIG. 4 illustrates an example switchable NFC/WPT antenna circuit and implementation of NFC and power connections on a charger pack of a smartphone, arranged in accordance with at least some embodiments described herein.

A diagram 400 shows a circuit of an example switchable NFC/WPT antenna, which may be a WPT antenna circuit modified to enable NFC functionality as described herein. The circuit for the switchable NFC/WPT antenna may include an inductor 404, a capacitor 402, a switch 408, and a resistor 406, where the inductor 404, the capacitor 402, and the resistor 406 may be connected in series. The switch 408 and the resistor 406 may be additional elements added to the WPT antenna that may enable the WPT antenna to function as an NFC antenna. In the example circuit for the WPT antenna, Q may be given by:

Q=2πf L/R,

where f is the frequency, L is the inductance and R is the total resistance of the circuit. In the case of the WPT antenna, the components of the circuit may be selected to produce an initial Q value around 1000. Opening the switch 408 may add a resistance, R1, of the resistor 406 to the circuit, which may have the effect of reducing the Q value as illustrated by:

$${Q}_{NFC} = \frac{2 π fL}{( R + R 1 )}$$

In an example embodiment, the resistance value of the resistor 406 may be selected to reduce the Q from 1000 to 10. As a result, when the switch is closed, the antenna may function as a WPT antenna with a Q value around 1000. When the switch is opened, the resistance, R1, may be added to reduce the Q value by a factor of 100 to around 10, and the antenna may function as an NFC antenna.

In a system according to embodiments, a switchable NFC/WPT antenna 452 including the modified circuit may enable at least three distinct functions when the switchable NFC/WPT antenna 452 is installed on a portable device 456 as shown in a diagram 450. Firstly, the NFC/WPT antenna 452 may enable wireless transmission of power between the portable device 456 and an external power source. Secondly, the NFC/WPT antenna 452 may enable active NFC when the portable device 456 is powered. Additionally, the NFC/WPT antenna 452 may enable passive NFC when the portable device 456 is unpowered. A controller or control circuit integrated with the NFC/WPT antenna 452 on the portable device may detect a power supply 454 on the portable device 456 and may switch between the at least three functions depending on the detected power levels of a power source of the portable device 456.

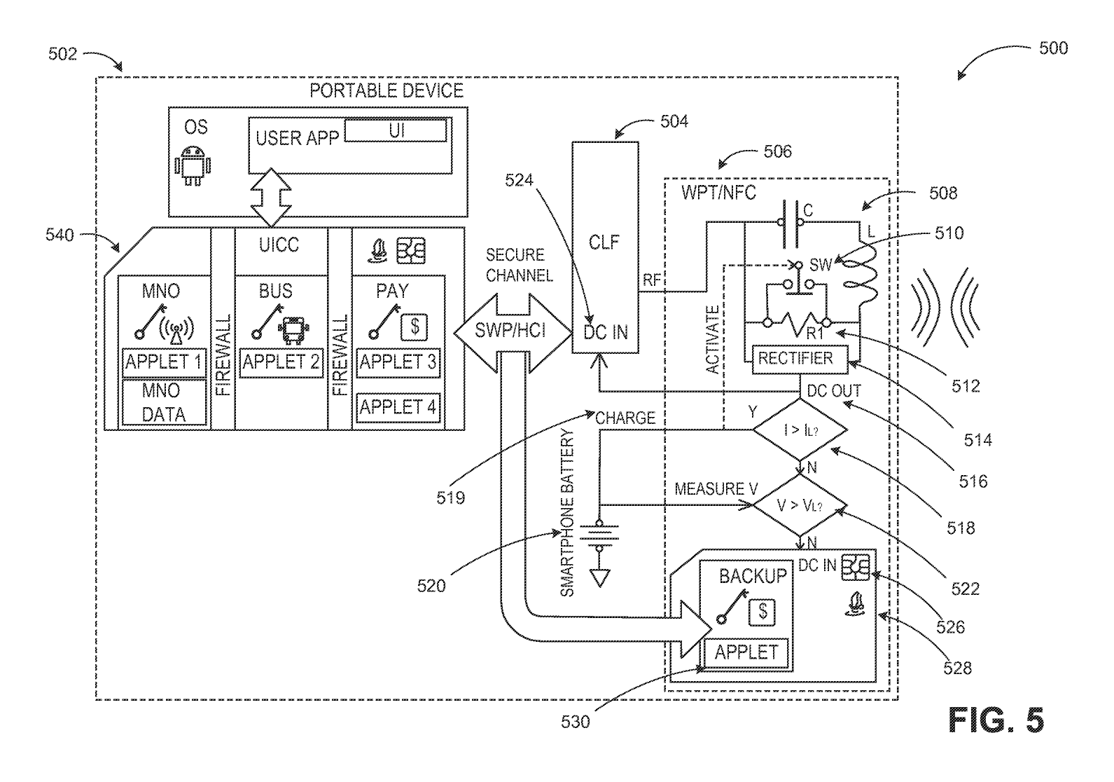

FIG. 5 illustrates a conceptual diagram of a portable device operational blocks implementing a switchable NFC/WPT antenna, arranged in accordance with at least some embodiments described herein.

As illustrated in a diagram 500, an NFC/WPT antenna 506 may be integrated with a portable device 502 such as a smartphone. The NFC/WPT antenna 506 may be an LC circuit 508 including an inductor and a capacitor connected in series as described previously, and may also include a switch 510 and a resistor 512, where the resistor 512 may also be connected in series with the capacitor and the inductor. The values for the capacitor (C) and the inductor (L) may be chosen such that a resonant frequency, f₀, of the NFC/WPT antenna 506 is 13.56 MHz, where f₀ is given by:

$${f}_{0} = \frac{1}{2 π \sqrt{LC}}$$

When the switch 510 is closed, a small resistance of the circuit elements may produce a Q value for the NFC/WPT antenna 506 of around 1000, where Q is given by:

Q=2πf L/R

In the scenario when the switch 510 is closed, the NFC/WPT antenna 506 may function as a WPT antenna for wireless transmission of power. When the switch 510 is open, a resistance, R1, of the added resistor 512 is added to give Q a new value given by:

$${Q}_{NFC} = \frac{2 π fL}{( R + R 1 )}$$

The value of the resistor 512, R1, may be selected so that Q_{NFC} may be around 10, which may allow enough radio frequency (RF) bandwidth to be transmitted via a contactless front end (CLF) 504 of the portable device 502 to enable NFC. In this case, the NFC/WPT antenna 506 may function as an active NFC antenna. When functioning as an active NFC antenna, the NFC may be powered by a battery 520 of the portable device 502.

In a system according to embodiments, when the switch 510 is open and/or closed, the NFC/WPT antenna 506 output may pass through a rectifier 514, which may convert the output to a DC current 516 in each described scenario. The DC current 516 may vary in magnitude based on the functionality, where the DC current 516 may be small in an NFC mode and large in the case of a WPT mode. A controller or a control circuit integrated with the portable device 502 may measure the DC current 516 and compare the DC current 516 to a threshold current, I_{L}. I_{L} may be set less than WPT charging currents, which may be about 1 A and more than induced NFC currents, which may be in a range from about 10 mA to about 100 mA. For example, I_{L} may be 100 mA. If the DC current 516 is larger than the I_{L}, then the control circuit may switch the NFC/WPT antenna 506 to the WPT mode. In the WPT mode, the switch 510 may be turned on for high Q efficiency, and the DC current 516 may be routed to charge 519 the battery 520. If the DC current 516 is less than the I_{L}, then the control circuit may switch the NFC/WPT antenna 506 to the NFC mode where the Q value is low.

In an example embodiment, after switching to the NFC mode, a voltage of the battery 520 may be measured 522. If the measured voltage is larger than a threshold voltage, V_{L}, (where V_{L} may be in a range from about 2.8 to about 3.2 V for the Li-Ion batteries often used in smartphones) required to power the portable device 502, then an active NFC mode may be initiated, where the battery 520 may employed to power NFC. In the active NFC mode, a SIM card 540 of the portable device 502 may also be powered by the battery 520 and may communicate with the CLF 504 over a single wire protocol (SWP) wire as described herein to enable NFC with one or more installed payment systems of the SIM card 540.

If the measured voltage is less than the V_{L} required to power the portable device 502, then a passive NFC mode may be initiated. The passive NFC mode may rely on radio frequency (RF) power derived from the small DC current or signal received through NFC/WPT antenna 506 in the NFC mode. For example, the small DC current 516 may be directed 524 to power an embedded SE chip 526 as part of a backup payment system 528 integrated with the portable device 502 and also to power the CLF 504. In the passive NFC mode, the SIM card 540 of the portable device 502 may be unpowered and may not respond to NFC signals. The backup payment system 528 may be implemented to enable payment when the battery 520 is uncharged, employing one or more backup payment applets 530 integrated with the backup payment system 528. The example current and voltage values provided herein are for illustration purposes and may vary depending on circuit and device configurations.

Table 1 below illustrates different modes of the NFC/WPT antenna 506 based on detected DC current 516 of the NFC/WPT antenna 506 and a measured voltage of the battery 520 of the portable device 502.

TABLE 1
At least three potential modes of an NFC/WPT antenna based on detected
current and battery voltage - 1) WPT 2) Active or powered NFC 3)
Passive or unpowered NFC.

| Rectifier Current I > I_{L} | Battery Voltage V > V_{L} | Function/Mode |
|---|---|---|
| No | No | Passive NFC |
| No | Yes | Active NFC |
| Yes | No | WPT |
| Yes | Yes | WPT |

In a further embodiment, the backup payment system may be installed directly on the SIM card 540, rather than integrated with the NFC/WPT antenna 506. When the passive NFC mode is entered, the DC current 516 may be directed to power the backup payment system on the SIM card 540. This example implementation may enable the payment system to function in a SIM-centric mode described previously with SIM software loaded by a mobile network operator. While the contactless backup payment system is described as a function enabled by the passive NFC mode, other contactless systems and applications may also be installed and powered by the NFC/WPT antenna 506 in the passive mode when the portable device is unpowered.

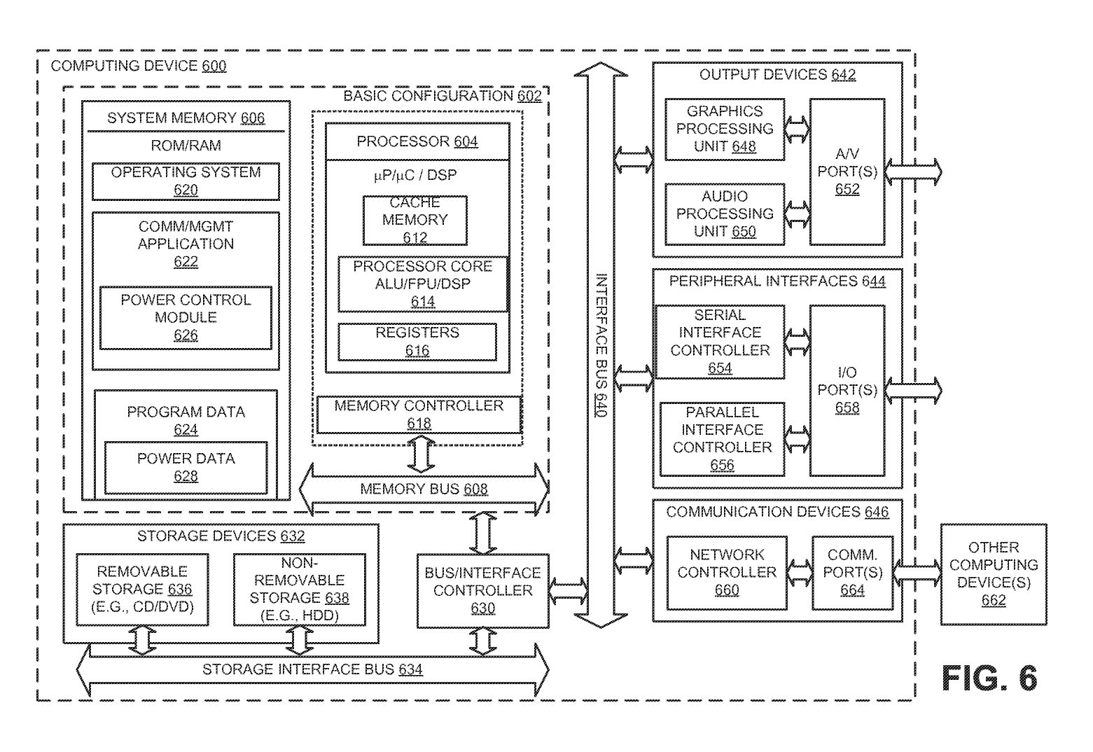

FIG. 6 illustrates a general purpose computing device 600, which may be used to implement adaptable coil-NFC antenna systems for powered and unpowered applications, arranged in accordance with at least some embodiments described herein.

For example, the computing device 600 may be used to implement modification of a wireless power coil to enable active and passive NFC antenna functionality in portable devices as described herein. In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit (FRU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a communication management application 622, a power control module 626, and program data 624, which may include power data 628. The communication management application 622 may together with the power control module 626 determine a power sufficiency of a portable device and may activate a switchable resistor to modify a Q value of an NFC/WPT antenna to enable wireless power transfer and active and passive NFC antenna functionality as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (far example, printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set of changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

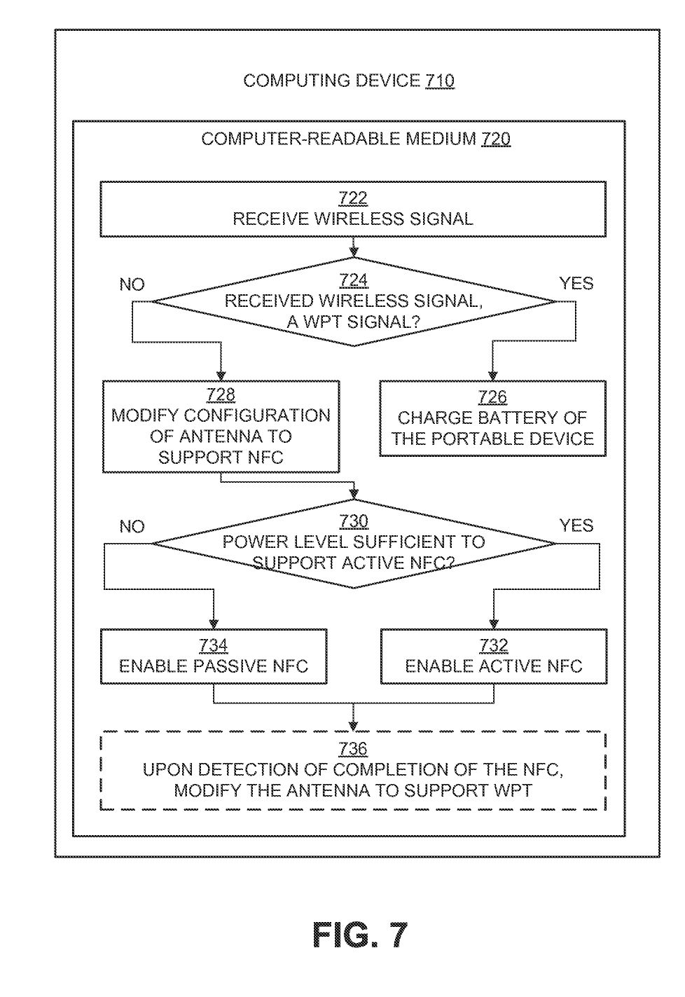

FIG. 7 is a flow diagram illustrating an example process to implement adaptable coil-NFC antenna systems for powered and unpowered applications that may be performed by a computing device such as the computing device in FIG. 6, arranged in accordance with at least some embodiments described herein.

Example methods may include one or more operations, functions or actions as illustrated by one or more of blocks 722, 724, 726, 728, 730, 732, 734, and/or 736, and may in some embodiments be performed by a computing device such as the computing device 600 in FIG. 6. The operations described in the blocks 722-736 may also be stored as computer-executable instructions in a computer-readable medium such as a computer-readable medium 720 of a computing device 710.

An example process to implement adaptable coil-NFC antenna systems for powered and unpowered applications may begin with block 722, “RECEIVE WIRELESS SIGNAL,” where a portable device with NFC and WPT capabilities may receive a wireless signal. The signal may be communications signal for NFC or power transfer signal for WPT.

Block 722 may be followed by decision block 724, “RECEIVED WIRELESS SIGNAL A WPT SIGNAL?” where a control circuit integrated with an NFC/WPT antenna on the portable device may determine whether the received signal is for NFC or WPT. The controller may accomplish this by comparing a current derived from the received signal to a threshold current value. If the derived current is higher than the threshold, the signal may be classified as WPT by the controller, otherwise as NFC.

Decision block 724 may be followed by block 726, “CHARGE BATTERY OF THE PORTABLE DEVICE,” where in response to an affirmative decision at the decision block 724, a battery of the portable device may be charged by a charging circuitry of the portable device using the current derived from the received wireless signal.

Decision block 724 may be followed by block 728, “MODIFY CONFIGURATION OF ANTENNA TO SUPPORT NFC”, where in response to a negative decision at the decision block 724, an antenna circuit of the portable device may be modified to accommodate NFC. In some examples, WPT may be the default configuration of the antenna circuit, and the antenna circuit may be modified (e.g., by adding a resistor in series with an inductor and a capacitor) to switch from a WPT mode to an NFC mode reducing a Q value of the antenna circuit. The controller may perform the modification operations or instruct a processor on the portable device to modify the antenna.

Block 728 may be followed by decision block 730, “POWER LEVEL OF A BATTERY SUFFICIENT TO SUPPORT ACTIVE NFC?” where the controller integrated with the portable device may detect a voltage level of the battery of the portable device. If the voltage is less than a threshold voltage, then the power level of the portable device may be determined to be insufficient to support active NFC, as described above.

Decision block 730 may be followed by block 732, “ENABLE ACTIVE NFC,” where in response to an affirmative decision at the decision block 730, the controller may enable near field communications with the source of the received wireless signal using a battery power of the portable device.

Decision block 730 may be followed by block 734, “ENABLE PASSIVE NFC”, where in response to a negative decision at the decision block 724, the controller may enable near field communications with the source of the received wireless signal using power derived from the received wireless signal through the low-Q configuration antenna circuit of the portable device.

Blocks 732 and 734 may be followed by optional block 736, “UPON DETECTION OF COMPLETION OF THE NFC MODIFY THE ANTENNA TO SUPPORT WPT” where upon completion of the near field communication session, the controller may modify the antenna to its default WPT configuration e.g., by removing the resistor). In other embodiments, the default mode of the antenna circuit may be NFC and switched to WPT upon detection of a WPT signal. In such configurations, it may be easier to detect a difference between the WPT and the NFC signals.

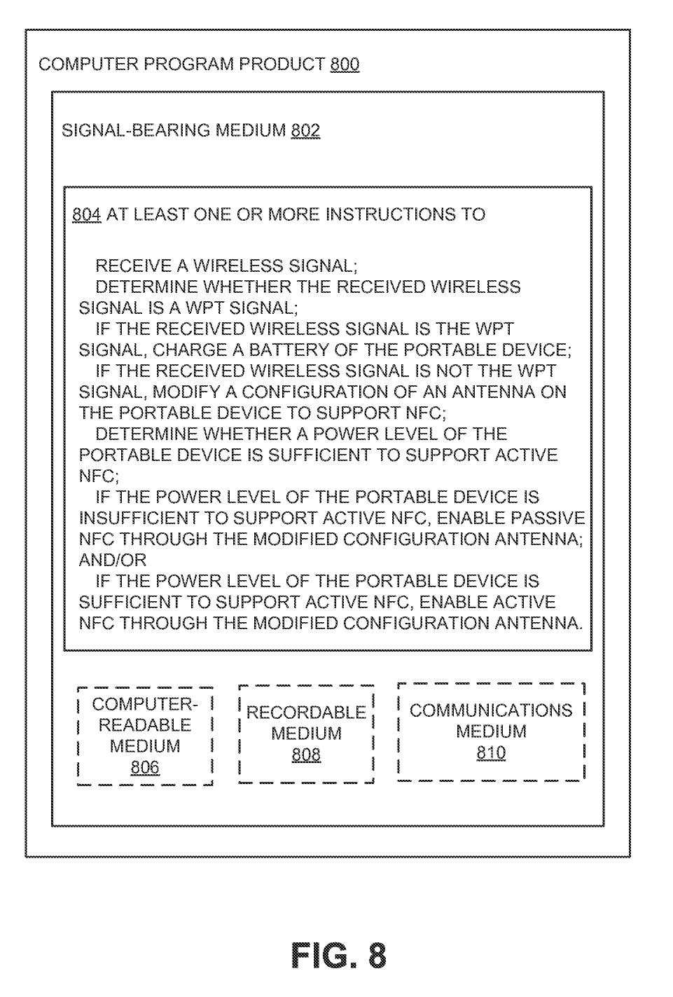

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, when executed by, for example, a processor may provide the functionality described herein. Thus, for example, referring to the processor 604 in FIG. 6, the communication management application 622 in conjunction with the power control module 626 may undertake one or more of the tasks shown in FIG. 8 in response to the instructions 804 conveyed to the processor 604 by the medium 802 to perform actions associated with implementation of adaptable NFC antennas to enable wireless power transfer and passive and/or active NFC functionality as described herein. Some of those instructions may include, for example, instructions to receive a wireless signal; determine whether the received wireless signal is a WPT signal; if the received wireless signal is the WPT signal, charge a battery of the portable device; if the received wireless signal is not the WPT signal, modify a configuration of an antenna on the portable device to support NFC determine whether a power level of the portable device is sufficient to support active NFC; if the power level of the portable device is insufficient to support active NFC, enable passive NFC through the modified configuration antenna; and/or if the power level of the portable device is sufficient to support active NFC, enable active NFC through the modified configuration antenna according to some embodiments described herein.

In some implementations, the signal bearing media 802 depicted in FIG. 8 may encompass computer-readable media 806, such as, but not limited to, a hard disk drive, a solid state drive, a Compact Disk (CD), a Digital Versatile Disk (DVD), a digital tape, memory, etc. In some implementations, the signal bearing media 802 may encompass recordable media 808, such as, but not limited to, memory, read/write (R/W) CDs, R/W DVDs, etc. In some implementations, the signal bearing media 802 may encompass communications media 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 by an RF signal bearing medium, where the signal bearing media 802 is conveyed by the wireless communications media 810 (for example, a wireless communications medium conforming with the IEEE 802.11 standard).

According to some examples, methods are described to provide adaptable near field communication (NFC) for powered and unpowered applications in a portable device. The method may include receiving a wireless signal; determining whether the received wireless signal is a wireless power transfer (WPT) signal; in response to a determination that the received wireless signal is the WPT signal, charging a battery of the portable device; and in response to a determination that the received wireless signal is not the WPT signal, modifying a configuration of an antenna on the portable device to support NFC. The method may also include determining whether a power level of the portable device is sufficient to support active NFC and in response to a determination that the power level of the portable device is insufficient to support active NFC, enabling passive NFC through the modified configuration antenna, where the passive NFC relies on power derived from the received wireless signal through the modified configuration antenna.

According to other examples, the method may further include in response to a determination that the power level of the portable device is sufficient to support active NFC, enabling active NFC through the modified configuration antenna, where the active NFC relies on power derived from the battery of the portable device. Modifying the configuration of the antenna to support NFC may include reducing a Q value of the antenna. Reducing the Q value of the antenna may include coupling a series resistor circuit between a capacitor circuit and an inductor circuit, wherein the capacitor circuit and the inductor circuit are coupled in series. Reducing the Q value of the antenna may also include reducing the Q value by a factor of about 100 or more.

According to further examples, determining whether the received wireless signal is the WPT signal may include deriving a current from the received wireless signal; comparing the derived current to a threshold current; and in response to a determination that the derived current is higher than the threshold current, determining the received wireless signal to be the WPT signal. The method may further include determining a completion of the passive NFC and modifying the configuration of the antenna to support WPT to the portable device. The configuration of the antenna to support WPT may be a default configuration. Modifying the configuration of the antenna to support WPT may include increasing a Q value of the antenna. Increasing the Q value of the antenna may include removing a series resistor circuit between a capacitor circuit and an inductor circuit. Increasing the Q value of the antenna may also include increasing the Q value by a factor of about 100 or more.

According to other examples, a portable device capable to support adaptable near field communication (NFC) for powered and unpowered applications is described. The portable device may include a processing block, a portable power source, a switchable antenna configured to support wireless power transfer (WPT) in a first configuration and NFC in a second configuration and to receive a wireless signal, and a secure element (SE) coupled to the switchable antenna. The SE may be configured to determine whether the received wireless signal is a WPT signal; in response to a determination that the received wireless signal is the WPT signal, charge a battery of the portable device; in response to a determination that the received wireless signal is not the WPT signal, modify a configuration of the antenna to the second configuration; determine whether a power level of the portable device is sufficient to support active NFC; in response to a determination that the power level of the portable device is insufficient to support active NFC, enable passive NFC through the antenna in the second configuration, where the passive NFC relies on power derived from the received wireless signal through the antenna in the second configuration; and in response to a determination that the power level of the portable device is sufficient to support active NFC, enable active NFC through the antenna in the second configuration, where the active NFC relies on power derived from the battery of the portable device.

According to some examples, the SE may be further configured to upon detection of a completion of the passive NFC or the active NFC, switch the antenna to the first configuration. The portable device may be a smartphone, a personal digital assistant (PDA), a tablet computer, a wearable computer, or a vehicle mount computer. The SE may be attached to a subscriber identity module (SIM) of the portable device, attached to an NFC module of the portable device that includes the antenna, or emulated through one or more applications executed by the processing block of the portable device. The first configuration and the second configuration of the antenna may include a high-Q mode and a low-Q mode of the antenna, respectively. The high-Q mode may include a capacitor circuit and an inductor circuit coupled in series, and the low-Q mode may include the capacitor circuit, the inductor circuit and a resistor circuit coupled in series. The SE may be further configured to employ the passive NFC for one or more of a payment application, a secure facility access application, a non-monetary resource access application, and an identification application.

According to further examples, a near field communication (NFC) module capable to support powered and unpowered applications is described. The NFC module array include a switchable antenna configured to support wireless power transfer (WPT) in a first configuration and NFC in a second configuration and to receive a wireless signal; and a secure element (SE) coupled to the switchable antenna. The SE may be configured to determine whether the received wireless signal is a WPT signal; in response to a determination that the received wireless signal is the WPT signal, charge a battery of a portable device that hosts the NFC module; in response to a determination that the received wireless signal is not the WPT signal, modify a configuration of the antenna to the second configuration; determine whether a power level of the portable device that hosts the NFC module is sufficient to support active NFC; in response to a determination that the power level of the portable device is insufficient to support active NFC, enable passive NFC through the antenna in the second configuration, where the passive NFC relies on power derived from the received wireless signal through the antenna in the second configuration; in response to a determination that the power level of the portable device is sufficient to support active NFC, enable active NFC through the antenna in the second configuration, where the active NFC relies on power derived from the battery of the portable device; and upon detection of a completion of the passive NFC or the active NFC, switch the antenna to the first configuration.

According to yet other examples, the NFC module may further include a rectifier circuit configured to provide a rectifier current, and the SE may be further configured to detect a battery voltage of the portable device and the rectifier current; in response to a determination that the rectifier current is lower than a current threshold and the battery voltage is lower than a voltage threshold, enable the passive NFC through the antenna in the second configuration; in response to a determination that the rectifier current is lower than the current threshold and the battery voltage is higher than the voltage threshold, enable the active NFC through the antenna in the second configuration; in response to a determination that the rectifier current is higher than the current threshold and the battery voltage is lower than the voltage threshold, enable the WPT through the antenna in the first configuration; and in response to a determination that the rectifier current is higher than the current threshold and the battery voltage is higher than the voltage threshold, enable the WPT through the antenna in the first configuration.

According to some examples, the first configuration and the second configuration of the antenna may include a high-Q mode and a low-Q mode of the antenna, respectively. The SE may be configured to enable the passive NFC communication for one or more of a payment application, a secure facility access application, a non-monetary resource access application, and an identification application executed on a subscriber identity module (SIM) of the portable device.

Various embodiments may be implemented in hardware, software, or combination of both hardware and software (or other computer-readable instructions stored on a non-transitory computer-readable storage medium and executable by one or more processors); the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually, and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (for example, as one or more programs executing on one or more computer systems), as one or more programs executing on one or more processors (for example, as one or more programs executing on one or more microprocessors), as firmware, or as virtually any combination thereof, and designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. Also, the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact many other architectures may be implemented which achieve the same or substantially similar functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being on associated may also be viewed as being “operably comparable”, to each other to achieve the desired functionality. Specific examples of operably comparable include but are not limited to physically connectable and/or physically interacting components and/or wirelessly interactable and/or wirelessly interacting components and/or logically interacting and/or interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. A method to provide adaptable near field communication (NFC) for powered and unpowered applications in a portable device, the method comprising;
receiving a wireless signal;
determining whether the received wireless sign is a wireless power transfer (WPT) signal;
in response to a determination that the received wireless signal is the WPT signal, charging a battery of the portable device;
in response to a determination that the received wireless signal is not the WPT signal, modifying a configuration of an antenna on the portable device to support NFC;
determining whether a power level of the portable device is sufficient to support active NFC; and
in response to a determination that the power level of the portable device is insufficient to support active NFC, enabling passive NFC through the modified configuration antenna, wherein the passive NFC relies on power derived from the received wireless signal through the modified configuration antenna.

2. The method of claim 1, further comprising:
in response to a determination that the power level of the portable device is sufficient to support active NFC, enabling active NFC through the modified configuration antenna, wherein the active NFC relies on power derived from the battery of the portable device.

3. The method of claim 1, wherein modifying the configuration of the antenna to support NFC comprises:
reducing a Q value of the antenna.

4. The method of claim 3, wherein reducing the Q value of the antenna comprises:
coupling a series resistor circuit between a capacitor circuit and an inductor circuit, wherein the capacitor circuit and the inductor circuit are coupled in series.

5. The method of claim 3, wherein reducing the Q value of the antenna comprises:
reducing the Q value by a factor of about 100 or more.

6. The method of claim 1, wherein determining whether the received wireless signal is the WPT signal comprises:
deriving a current from the received wireless signal;
comparing the derived current to a threshold current; and
in response to a determination that the derived current is higher than the threshold current, determining the received wireless signal to be WPT signal.

7. The method of claim 1, further comprising:
determining a completion of the passive NFC; and
modifying the configuration of the antenna to support WPT to the portable device.

8. The method of claim 7, wherein the configuration of the antenna to support WPT is a default configuration.

9. The method of claim 7, wherein modifying the configuration of the antenna to support WPT comprises:
increasing a Q value of the antenna.

10. The method of claim 9, wherein increasing the Q value of the antenna comprises:
removing a series resistor circuit between a capacitor circuit and an inductor circuit.

11. The method of claim 9, wherein increasing the Q value of the antenna comprises:
increasing the Q value by a factor of about 100 or more.

12. A portable device capable to support adaptable near field communication (NFC) for powered and unpowered applications, the portable device comprising;
a processing block;
a portable power source;
a switchable antenna configured to support wireless power transfer (WPT) in a first configuration and NFC in a second configuration and to receive a wireless signal; and
a secure element (SE) coupled to the switchable antenna, wherein the SE is configured to:
determine whether the received wireless signal is a WPT signal;
in response to a determination that the received wireless signal is the WPT signal, charge a battery of the portable device;
in response to a determination that the received wireless signal is not WPT signal, modify a configuration of the antenna to the second configuration;
determine whether a power level of the portable device is sufficient to support active NFC;
in response to a determination that the power level of the portable device is insufficient to support active NFC, enable passive NFC through the antenna in the second configuration, wherein the passive NFC relies on power derived from the received wireless signal through the antenna in the second configuration; and
in response to a determination that the power level of the portable device is sufficient to support active NFC, enable active NFC through the antenna in the second configuration, wherein the active NFC relies on power derived from the battery of the portable device.

13. The portable device of claim 12, wherein the SE is further configured to:
upon detection of a completion of the passive NFC or the active NFC, switch the antenna to the first configuration.

14. The portable device of claim 12, wherein the portable device is one of a smartphone, a personal digital assistant (PDA), a tablet computer, a wearable computer, or a vehicle mount computer.

15. The portable device of claim 12, wherein the SE is one of: attached to a subscriber identity module (SIM) of the portable device, attached to an NFC module of the portable device that includes the antenna, or emulated through one or more applications executed by the processing block of the portable device.

16. The portable device of claim 12, wherein the first configuration and the second configuration of the antenna include a high-Q mode and a low-Q mode of the antenna, respectively.

17. The portable device of claim 16, wherein the high-Q mode includes a capacitor circuit and an inductor circuit coupled in series, and the low-Q includes the capacitor circuit, the inductor circuit and a resistor circuit coupled in series.

18. The portable device of claim 12, wherein the SE is further configured to employ the passive NFC for one or more of a payment application, a secure facility access application, a non-monetary resource access application, and an identification application.

19. A near field communication (NFC) module capable to support powered and unpowered applications, the NFC module comprising:
switchable antenna configured to support wireless power transfer (WPT) in a first configuration and NFC in a second configuration and to receive a wireless signal; and
a secure element (SE) coupled to the switchable antenna, wherein the SE is configured to:
determine whether the received wireless signal is a WPT signal;
in response to a determination that the received wireless signal is the WPT charge a battery of a portable device that hosts the NFC module;
in response to a determination that the received wireless signal is not the WPT signal, modify a configuration of the antenna to the second configuration;
determine whether a power level of the portable device that hosts the NFC module is sufficient to support active NFC;
in response to a determination that the power level of the portable device is insufficient to support active NFC, enable passive NFC through the antenna in the second configuration, wherein the passive NFC relies on power derived from the received wireless signal through the antenna in the second configuration;
in response to a determination that the power level of the portable device is sufficient to support active NFC, enable active NFC through the antenna in the second configuration, wherein the active NFC relies on power derived from the battery of the portable device; and
upon detection of a completion of the passive NFC or the active NFC, switch the antenna to the first configuration.

20. The NFC module of claim 19, further comprising a rectifier circuit configured to provide a rectifier current, wherein the SE is further configured to:
detect a battery voltage of the portable device and the rectifier current;
in response to a determination that the rectifier current is lower than a current threshold and the battery voltage is lower than a voltage threshold, enable the passive NFC through the antenna in the second configuration;
in response to a determination that the rectifier current is lower than the current threshold and the battery voltage is higher than the voltage threshold, enable the active NFC through the antenna in the second configuration;
in response to a determination that the rectifier current is higher than the current threshold and the battery voltage is lower than the voltage threshold, enable the WPT through the antenna in the first configuration; and
in response to a determination that the rectifier current is higher than the current threshold and the battery voltage is higher than the voltage threshold, enable the WPT through the antenna in the first configuration.

21. The NFC module of claim 19, wherein the first configuration and the second configuration of the antenna include a high-Q mode and a low-node of the antenna, respectively.

22. The NFC module of claim 19, wherein the SE is configured to enable the passive NFC communication for one or more of a payment application, a secure facility access application, a non-monetary resource access application, and an identification application executed on a subscriber identity module (SIM) of the portable device.
